(19) United States
(12) Patent Application Publication
(10) Pub. No.: US 2025/0368833 A1
(43) Pub. Date: Dec. 4, 2025

(54) ANTI-CORROSION CERIUM-MODIFIED ZINC PHOSPHATE DECORATED GRAPHENE OXIDE NANOPLATFORM

(71) Applicant: Zentek Ltd., Guelph (CA)

(72) Inventors: Seyyedarash HADDADI, Guelph (CA); Colin VAN DER KUUR, Kelowna (CA)

(73) Assignee: Zentek Ltd., Guelph, ON (CA)

(21) Appl. No.: 18/874,567

(22) PCT Filed: Jun. 13, 2023
(86) PCT No.: PCT/CA2023/050818

§ 371 Date: Dec. 12, 2024

Related U.S. Application Data
(60) Provisional application No. 63/352,723, filed on Jun. 16, 2022.

(51) Int. Cl. C09D 5/08; C09D 7/62; C09D 163/00

(52) U.S. Cl. CPC C09D 5/084; C09D 7/62; C09D 163/00

(57) ABSTRACT

An anti-corrosion coating additive comprising graphene oxide nanoplatforms decorated with cerium-modified zinc phosphate nanopigments, Ce³⁺, Zn²⁺ and PO₄³⁻ inhibitive components releasable from the nanopigments when dispersed in the coating, and where porosity allows the nanoplatforms to act as nanocarriers for organic corrosion inhibitors.

### TECHNICAL FIELD OF THE INVENTION

The present invention relates to anti-corrosion coatings for application to metallic substrates, and more particularly to additives to enhance anti-corrosion coatings.

### BACKGROUND OF THE INVENTION

It is known in the art to apply anti-corrosive coatings to metallic substrates that are susceptible to degradation, such coatings for example including paints with thermoset or thermoplastic matrices and anti-corrosive pigments. Known anti-corrosive pigments such as metallic zinc and aluminum and zinc phosphate are commonly blended into a binder for application to the vulnerable substrate to prevent or at least reduce corrosion. Various corrosion inhibitors are known for use as additives for anti-corrosion coatings.

Graphene oxide (GO) nanoplatforms, due to their large surface area, could provide good barrier properties as an additive in anti-corrosion protective coatings. However, the wide variety of oxygen-containing functional groups on the surface of the GO nanoplatforms undesirably increases the hydrophilicity level of the coating, thus countering the desired effect of preventing corrosive substances from contacting the metallic substrate. While the reduction of GO nanoplatforms to reduced GO (rGO) can increase their hydrophobicity via chemical and thermal methods and may helpfully form many aggregations in the coating, this would create many structural defects which would accordingly reduce the barrier efficiency of the nanoplatforms.

What is needed, therefore, is a method for modifying GO nanoplatforms to enhance their utility as an additive for anti-corrosion coatings.

### SUMMARY OF THE INVENTION

According to aspects of the present invention, cerium (Ce³⁺) modified zinc phosphate (CeZnP) nanopigments are synthesized and grafted on the surface of GO nanoplatforms. Zinc phosphate (ZnP) pigment is a known anti-corrosive pigment used in certain industries to reduce the destructive effects of corrosion reactions. The decoration of GO nanoplatforms with CeZnP nanopigments (GO-CeZnP) may thus desirably reduce their surface hydrophilicity. The release of Ce³⁺, Zn²⁺, and PO₄³⁻ inhibitive components from GO-CeZnP nanoplatforms can mitigate both anodic and cathodic reactions on the metallic substrates. Decorated CeZnP nanopigments may further provide porous media for encapsulation of secondary organic corrosion inhibitors, and GO-CeZnP nanoplatforms can act as nanocarriers for organic corrosion inhibitors. Despite the encapsulation of organic corrosion inhibitors in porous media of GO-CeZnP nanoplatforms, these corrosion inhibitors can interact chemically with CeZnP nanopigments via the electrostatic/ionic attractions, thus potentially providing on-demand release of organic corrosion inhibitors as well as the Ce³⁺, Zn²⁺, and PO₄³⁻ inhibitive components. In addition, the presence of uniformly dispersed GO-CeZnP nanoplatforms in the coatings may enhance their barrier properties. Thus, it is believed that the diffusion rate of corrosive specimens such as water, oxygen and chloride ions decreases, taking a longer time to reach the surface of the metallic substrates.

As one example of a corrosion inhibitor that can be loaded in the porosity of decorated GO nanoplatforms according to some embodiments of the present invention, synthesized GO-CeZnP nanostructures can be used as nanocarriers for the encapsulation of sodium lignosulfonate (SLS), which is used as an industrial corrosion inhibitor, to potentially enable a controlled on-demand release of SLS during corrosion reactions.

According to a first broad aspect of the present invention, there is provided an anti-corrosion coating additive comprising graphene oxide nanoplatforms decorated with cerium-modified zinc phosphate nanopigments.

In exemplary embodiments of the first aspect of the present invention, the additive comprises Ce³⁺, Zn²⁺ and PO₄³⁻ inhibitive components releasable from the nanopigments when dispersed in the coating.

In some exemplary embodiments, the graphene oxide nanoplatforms comprise porosity, the porosity to receive an organic corrosion inhibitor. In some preferred embodiments, the organic corrosion inhibitor is sodium lignosulfonate.

According to a second broad aspect of the present invention, there is provided a method for manufacturing an additive for use with an anti-corrosion coating, the method comprising the steps of:
a. forming graphene oxide (GO) nanoplatforms and dispersing in distilled water to form a generally uniform suspension;
b. dissolving Zn(NO₃)₂ and Ce(NO₃)₂ in water to form a solution;
c. adding the solution to the suspension to form a Ce—Zn doped GO suspension;
d. dissolving Na₃(PO₄) in water to form a P solution;
e. adding the P solution to the Ce—Zn doped GO suspension to form a Ce—Zn—P doped GO suspension; and
f. heating and washing the Ce—Zn—P doped GO suspension to reduce the GO forming reduced GO nanoplatforms and form decorated Ce—Zn—P nanoparticles on the surface of the reduced GO nanoplatforms to form the additive.

Some exemplary methods further comprise the steps after step e. of: dissolving sodium lignosulfonate in water to form a mixture; and adding the mixture to the Ce—Zn—P doped GO suspension to load the sodium lignosulfonate on GO-Ce—Zn—P in the Ce—Zn—P doped GO suspension. The step of adding the mixture to the Ce—Zn—P doped GO suspension is preferably conducted under a vacuum to remove air trapped between layers in the GO-Ce—Zn—P to allow access by the mixture.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 is a schematic illustration of the synthesis of GO and GO-CeZnP nanoplatforms.

FIG. 2 shows images of samples for electrochemical measurements.

FIG. 3 shows FE-SEM images of synthesized GO and Ce—Zn—P decorated reduced GO nanoplatforms.

FIG. 4 shows EDS results of GO-CeZnP nanoplatforms.

FIG. 5 shows XRD patterns of GO and GO-CeZnP nanoplatforms.

FIG. 6 shows FT-IR spectra of GO and GO-CeZnP nanoplatforms.

FIG. 7 shows potentiodynamic polarization curves of bare mild steel plates immersed for 110 hours in the blank and GO-CeZnP extract solutions.

FIG. 8 shows impedance Bode diagrams of different coatings after 5 days of immersion in the saline electrolyte.

FIG. 9 shows impedance Bode diagrams of different coatings after 14 weeks of immersion in the saline electrolyte.

FIG. 10 illustrates the chemical structure of sodium lignosulfonate (SLS) as an industrial corrosion inhibitor.

FIG. 11 shows FT-IR spectra of SLS and GO-CeZnP before and after SLS loading.

FIG. 12 shows FT-IR spectra of SLS and SLS doped GO-CeZnP nanostructures with different CeZnP contents.

Exemplary embodiments will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to graphene oxide nanoplatforms that are decorated with cerium-modified zinc phosphate, as additives for anti-corrosive coatings applicable to metallic substrates. The Ce³⁺, Zn²⁺ and PO₄³⁻ inhibitive components are releasable in the coating, and the decorated nanoplatforms may further provide porosity enabling the nanoplatforms to act as nanocarriers for organic corrosion inhibitors such as sodium lignosulfonate.

Following are exemplary methods for preparing decorated nanoplatforms according to embodiments of the present invention, including test results on the produced nanoplatforms.

### Experimental Results

### Preparation of GO Nanoplatforms

1 g graphite powder was soaked in 30 mL H₂SO₄ (98%) and 5 mL H₃PO₄ (85%) solution under a fume hood in an Erlenmeyer flask under stirring conditions at 50° C. and 300 rpm for 18 hours. The suspension was sonicated 3 times every 6 hours using a bath sonicator for 30 minutes each time. Then, 6 g KMnO₄ was added gradually to the previous mixture. An ice/water bath was used to decrease the temperature of the mixture during the exothermic oxidation reactions. The mixture was kept under continuous stirring for up to 12 hours at 35° C. Bath sonication (15-30 minutes) was used 3 times after 8 hours of stirring in this stage.

Next, 100 mL of cold distilled water (2-5° C.) was added to the previous mixture. In this stage, the temperature of the mixture was kept below 5° C. using an ice bath. Then, H₂O₂ (30%) was added drop-by-drop to the diluted mixture until the color of the mixture changed from dark brown to yellow. Before purification, a 30-minute bath sonication of the mixture was used to accelerate the separation of exfoliated GO nanoplatforms from each other.

The final suspension was washed 3 times with HCl (1 M) and three times with a mixture of water/ethanol (8:2 v/v). Bath sonication (30 minutes) was used between the purification steps to accelerate the removal of impurities intercalated between the GO layers. The pH of the sample was adjusted to between 3 and 4 during the centrifuging by 1 M KOH solution for better sedimentation. The final GO nanoplatforms with 33% oxygen content were then dispersed in distilled water and stored for the next stages.

Decoration of GO Nanoplatforms with CeZnP Nanopigments

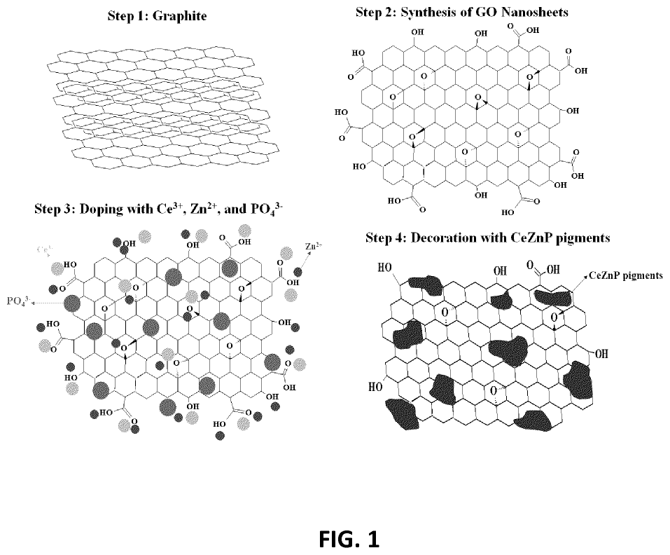

The decoration of GO nanoplatforms with CeZnP nanopigments was performed via a hydrothermal method. For this purpose, 0.5 g GO was dispersed in 50 mL water in a first container using a probe sonicator. In a second container, 0.06 M Zn(NO₃)₂ and 0.06 M Ce(NO₃)₃ were dissolved in 50 mL water. Then, the second solution was added to the first GO suspension under stirring conditions for 1 hour at room temperature to form a Ce—Zn-GO suspension. After that, 0.06 M Na₃(PO₄) was dissolved in 50 mL water and then added to the previous Ce—Zn-GO suspension under stirring conditions for 1 hour at room temperature to form a Ce—Zn—P-GO suspension. Finally, the Ce—Zn—P-GO suspension was transferred in a Teflon-sealed autoclave and kept at 100° C. for 12 hours. After this period, the black GO-CeZnP nanoplatforms were separated using centrifugation, washed three times with water, and stored in a paste form. Turning to FIG. 1, all steps of the synthesis of GO nanoplatforms from graphite and reduction of GO to make GO-CeZnP nanoplatforms are shown schematically.

### Preparation of GO-CeZnP/Epoxy Nanocomposites

A GO-CeZnP epoxy nanocomposite was then fabricated by direct dispersion of dehydrated GO-CeZnP nanoplatforms in an epoxy matrix using a solvent-exchanged method. To enable this, GO-CeZnP nanoplatforms were washed with ethanol four times to remove all water molecules. Then, the dehydrated GO-CeZnP nanoplatforms were washed four times with toluene as a solvent compatible with epoxy. In the final stage of washing with toluene, all GO-CeZnP nanoplatforms were sonicated in toluene using probe sonication to break aggregations.

Then, 0.15 wt. % of GO-CeZnP nanoplatforms was dispersed separately in epoxy resin using a high-speed mechanical mixer for 3 hours, and probe sonication followed for 15 minutes. Also, a blank epoxy resin containing no nanoplatforms was prepared as a reference sample. As ultrasonication may lead to partial polymer chain scission, the blank epoxy resin was also ultrasonicated to ensure that all the conditions for comparison were the same except nanoplatforms concentrations.

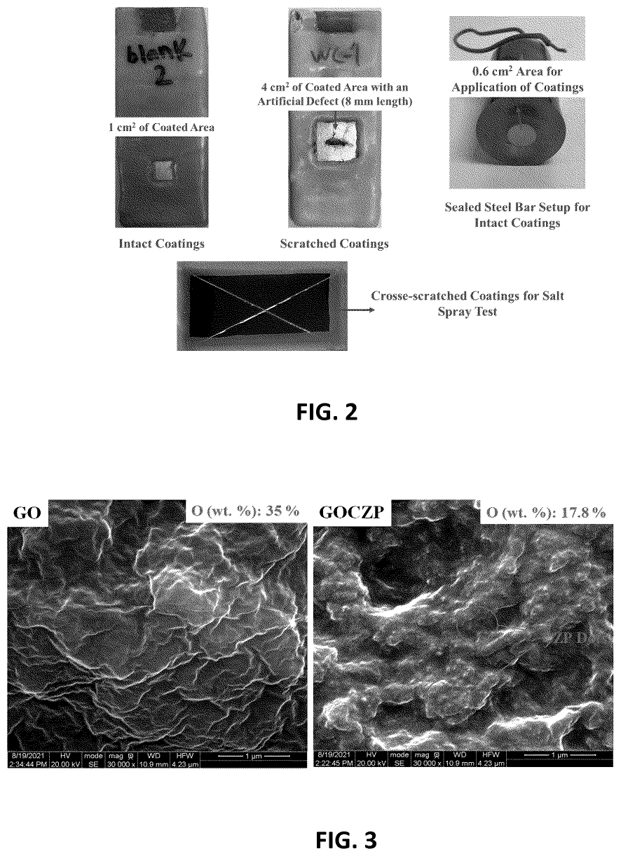

Mild steel plates (8 cm×10 cm×0.2 cm) abraded by emery papers no. 600, 800, and 1000 were cleaned with acetone. Then, the epoxy nanocomposites containing 0.15 wt. % GO-CeZnP nanoplatforms were mixed with polyamine hardener at a stoichiometric ratio (1:0.95 weight ratio of epoxy resin to polyamine). Immediately after mixing epoxy coatings with hardener, the coating materials were applied on the cleaned mild steel substrates by a four-side film applicator. The coated steel plates remained at room temperature for 1 week. To ensure complete curing, the plates were placed in an oven at 100° C. for 3 hours. The dry coatings thickness determined by the film applicator was 90±5 μm. A surface area of 4×6 cm² of the coated mild steel plates was exposed to salt spray while the rest of the area was sealed using a hot melt beeswax-colophony mixture. The coating was X-scribed before exposing it to salt spray. For EIS measurements, the area exposed to the 3.5 wt. % NaCl solution was 1 cm² for intact coatings and 4 cm² with an artificial defect (10 mm in length) for scratched coatings. Triplicates were prepared for each specimen for EIS and salt spray measurements. ST37 mild steel plates were used as metallic substrates for all electrochemical measurements. FIG. 2 shows real images of samples for electrochemical measurements.

### Results

FE-SEM-EDS: FIG. 3 presents the FE-SEM and EDS results for GO-CeZnP nanoplatforms. According to FIG. 3, the oxygen content for GO is 35% while after the reduction reactions by CeZnP nanopigments, it reached 17.8 wt. %. In addition, the average lateral size of GO-CeZnP nanoplatforms is lower than GO nanoplatforms, which may be due to the sonication process and the removal of oxygen-containing groups via the reduction reactions.

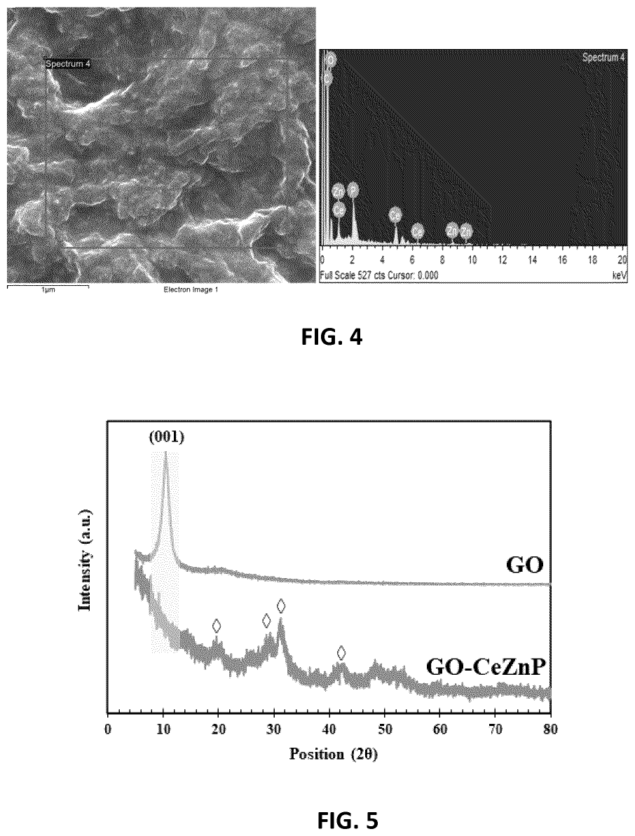

The EDS results of GO-CeZnP nanoplatforms are shown in FIG. 4. According to the EDS results, the weight percentages of Ce³⁺, Zn²⁺, and PO₄³⁻ in decorated CeZnP nanopigments on the surface of GO platforms are 9.03, 2.27, and 2.73 wt. %, respectively.

XRD: The crystalline phases of GO and GO-CeZnP nanoplatforms were evaluated using XRD analysis and the results are presented in FIG. 5. The only characteristic XRD peak for GO nanoplatforms, related to the (001) plane of carbon atoms, is centered at 2θ=11.5°. In terms of GO-CeZnP nanoplatforms, the (001) plane peak disappeared after the decoration with CeZnP nanopigments, proving the successful reduction of GO nanoplatforms. The characteristic peaks at the position range of 20-55° C. are assigned to crystalline phases of decorated CeZnP nanopigments. The specific peak at 2θ=20.2° is assigned to carbonaceous structures of GO nanoplatforms with sp³ carbon atoms. The characteristic peaks of Ce³⁺—Zn²⁺—PO₄³⁻ and Zn²⁺—PO₄³⁻ networks appeared at 28.7, 31.4, and 43.8°. During the synthesis, firstly, Ce³⁺ and Zn²⁺ cations physically adsorb on the surface of GO nanoplatforms via the electrostatic attractive forces and π→cation interactions with functional groups of GO nanoplatforms. Then, the same electrostatic attractive forces account for the adsorption of PO₄³⁻ components on the surface of Ce³⁺/Zn²⁺ doped GO nanoplatforms. In the hydrothermal step, by the polymerization of PO₄³⁻ components in the presence of Ce³⁺/Zn²⁺ cations, final decorated CeZnP nanopigments are formed.

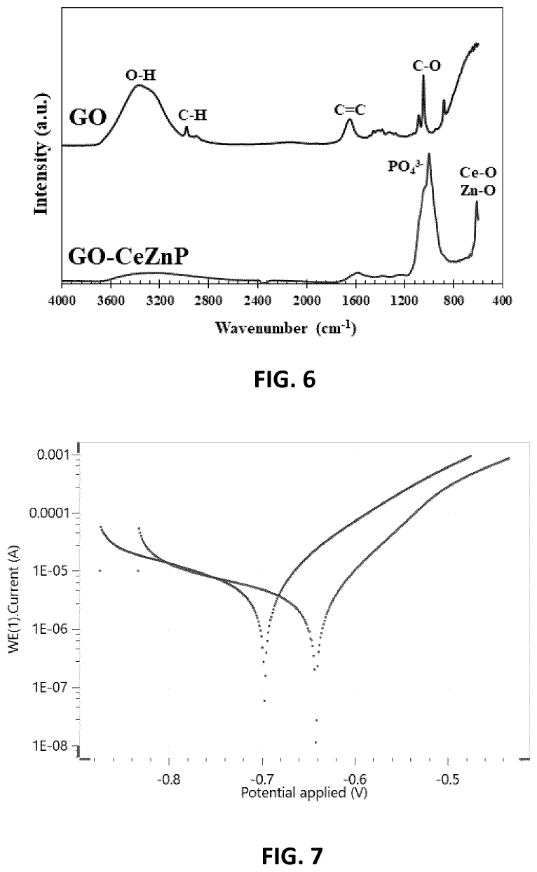

FT-IR: As shown in FIG. 6, the FT-IR spectrum of GO nanoplatforms is completely different than that of GO-CeZnP nanoplatforms. In the spectrum of GO nanoplatforms, the characteristic peaks at 3317, 2840-2940, 1628, and 1047 cm⁻¹ are attributed to stretching vibrations of O—H, C—H, C+C, and C—O bonds, presenting the existence of oxygenated functionalities on the surface of GO nanoplatforms. It is clear that after the decoration of CeZnP nanopigments, most of the aforementioned peaks are gone and a few new peaks appeared accordingly. In the spectrum of GO-CeZnP nanoplatforms, the overlapped peaks at 1002 and 1049 cm⁻¹ are related to the stretching vibration of PO₄³⁻ components. Also, the small peak at 617 cm⁻¹ is assigned to the Ce—O and Zn—O bonds in CeZnP nanopigments. XRD and FT-IR results confirmed the successful decoration of GO nanoplatforms with CeZnP nanopigments.

OCP measurement: To confirm the release of Ce³⁺, Zn²⁺, and PO₄³⁻ components from GO-CeZnP nanoplatforms in a standard saline solution (3.5 wt. % NaCl), an OCP test was conducted on the extract solution. For this purpose, 1 g GO-CeZnP nanoplatforms was dispersed in 1 L of the saline solution under stirring conditions. After 24 hours, all residue GO-CeZnP nanoplatforms were filtered and the OCP test was conducted on the prepared clear solution. The OCP results are shown in Table 1. According to the OCP results of the CeZnP extract, Ce³⁺, Zn²⁺, PO₄³⁻, and NO₃₋ components are capable of release from GO-CeZnP nanoplatforms in the saline media to protect metallic substrates against corrosion in the solution phase.

TABLE 1
OCP results of the GO—CeZnP extract.

μg

[symbol]

| Sample | Ce | Zn | PO [symbol] | NO [symbol] |
|---|---|---|---|---|
| GO—CeZnP | 42.5 | 1529 | 1000 | 9540 |

[symbol]

indicates data missing or illegible when filed

Potentiodynamic polarization: A potentiodynamic polarization test was performed on uncoated samples immersed for 110 hours in the extract solutions. The potentiodynamic polarization curves are shown in FIG. 7. As can be seen, in the presence of GO-CeZnP extract, the corrosion potential shifted to more negative potentials, showing the cathodic protection of the GO-CeZnP extract is more dominant than anodic protection. Also, both anodic and cathodic branches were depressed in the presence of the GO-CeZnP extract, proving the mitigation of both anodic and cathodic reactions.

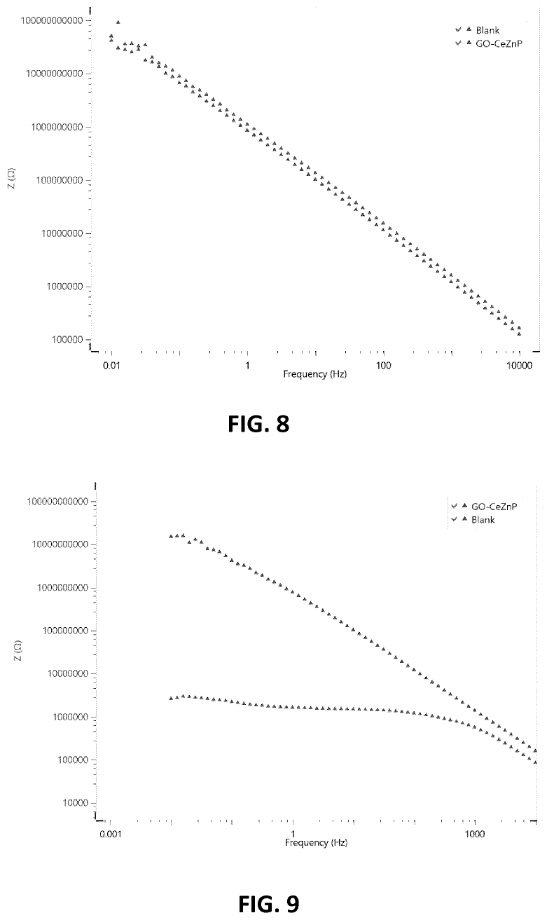

Electrochemical impedance spectroscopy (EIS): EIS analysis was used to evaluate the impedance values of different coatings after 14 weeks of immersion in 3.5 wt. % NaCl solution. The impedance Bode diagrams of different coatings after 5 days and 14 weeks of immersion in the saline electrolyte are depicted in FIGS. 8 and 9, respectively.

The value of Z at the lowest frequency (0.01 Hz) is equal to the total impedance or total resistance of the coating. Thus, based on the data shown in FIG. 8, the total resistance of the blank epoxy coating is around 4.2×10¹⁰ Ωcm⁻², while for the nanocomposite coating the total resistance is around 5.1×10¹⁰ Ωcm⁻².

After 14 weeks of the immersion, the total resistance of the blank epoxy coating reached around 2×10⁶ Ωcm⁻², while the nanocomposite coating showed the total resistance of around 1.5×10¹⁰ Ωcm⁻². In addition, the GO-CeZnP-epoxy coating showed the highest anti-corrosion resistance after 14 weeks of immersion in comparison with other coatings. With immersion time, the corrosive electrolyte diffuses through the coating and reaches the metal/coating interface. By contacting the metal surface with the electrolyte and the development of both anodic and cathodic sites, the deteriorating process of the coating is started. It is believed that the dispersion of GO-CeZnP nanoplatforms creates nanoscale barriers against the diffusion of the electrolyte and blocks micro defects inside the coating. Thus, the diffusion of the electrolyte takes longer. Also, the release of Ce³⁺, Zn²⁺, and PO₄³⁻ components during the immersion are believed to mitigate corrosion reactions. These components are capable of reacting with OH⁻ and Fe²⁺ components, generated by cathodic and anodic reactions, respectively, and producing insoluble Ce(OH)₃, CeO₂, Zn(OH)₂, and Fe₃(PO₄)₂. These formed components can be deposited on active anodic and cathodic sites and mitigate the corrosion reactions.

As noted above, decorated GO nanoplatforms in accordance with embodiments of the present invention may present porosity that can allow the nanoplatforms to act as a nanocarrier for organic corrosion inhibitors. As one non-limiting example, sodium lignosulfonate (SLS) may be such a corrosion inhibitor loaded on the nanoplatforms.

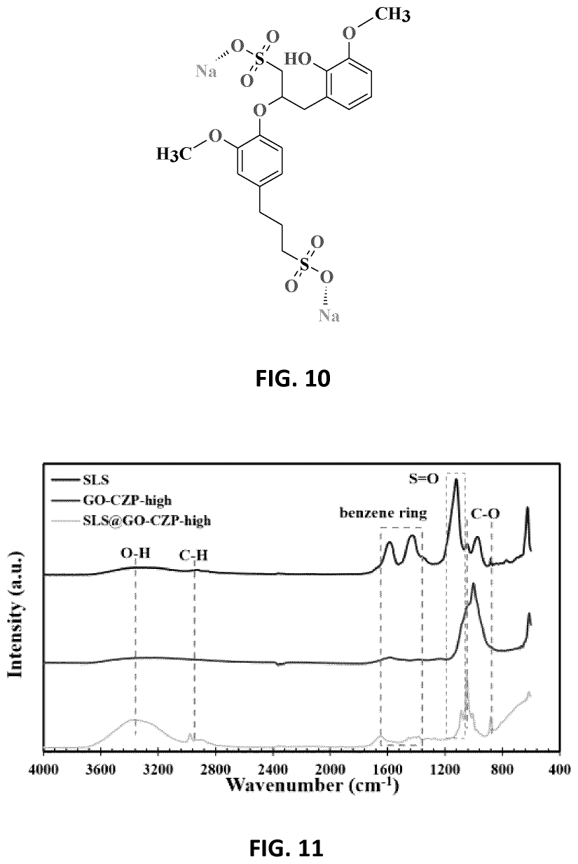

FIG. 10 shows the chemical structure of SLS, used as an industrial corrosion inhibitor. In these samples, the synthesized GO-CeZnP nanostructures were used as nanocarriers for the encapsulation of SLS to potentially provide a controlled on-demand release of SLS during the corrosion reactions.

Loading of GO-CeZnP with corrosion inhibitor: For loading of SLS in GO-CeZnP, 1 g of synthesized GO-CeZnP was dispersed in 50 mL water in a first container to form a suspension. In a second container, 5 g SLS was dissolved in 50 mL water. The mixture from the second container was added to the first suspension under stirring conditions at room temperature for 3 hours under a vacuum to form SLS@GO-CeZnP nanostructures. After that the SLS@GO-CeZnP nanostructures were collected with centrifugation and washed one time with water and one time with ethanol. The reason for using the vacuum is to remove the trapped air between layered structures of the GO-CeZnP and replace them with an SLS-containing solution.

FT-IR results: GO-CeZnP nanostructures were synthesized at different loadings of CeZnP, denoted as GO-CZP-low, GO-CZP-mid, and GO-CZP-high herein. FIG. 11 shows the FT-IR spectra of SLS, GO-CZP-high, and SLS loaded GO-CZP (SLS@GO-CZP-high). According to FIG. 11, the FT-IR spectrum of SLS@GO-CZP-high is very close to that of SLS.

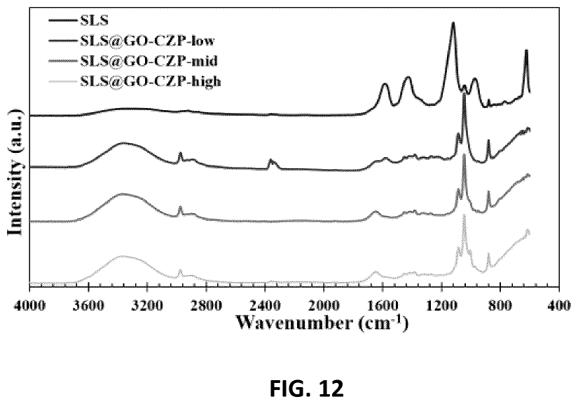

In these spectra, the peaks at 3334, 2860-2940, 1570 and 1401, 1200, 1037 and 881 cm⁻¹ are assigned to stretching vibrations of O—H, C—H, benzene rings, S═O, and C—O of SLS molecules, respectively. The differences between FT-IR spectra of GO-CeZnP nanostructures before and after SLS loading confirmed the SLS loading process. FIG. 12 presents the FT-IR spectra of different GO-CeZnP samples.

It is obvious that despite different contents of CZP nanostructures, all SLS@GO-CZP-low, SLS@GO-CZP-mid, and SLS@GO-CZP-high nanostructures illustrated the same FT-IR patterns after SLS loading, showing the successful loading of SLS molecules in these nanostructures.

The foregoing is considered as illustrative only of the principles of the present invention. The scope of the claims should not be limited by the exemplary embodiments set forth in the foregoing, but should be given the broadest interpretation consistent with the specification as a whole.

1. An anti-corrosion coating additive comprising reduced graphene oxide nanoplatforms decorated with cerium-modified zinc phosphate nanopigments.

2. The additive of claim 1 comprising Ce³⁺, Zn²⁺ and PO₄³⁻ inhibitive components releasable from the nanopigments when dispersed in the coating.

3. The additive of claim 1 wherein the anti-corrosion coating additive mitigates both anodic and cathodic corrosion reactions.

4. The additive of claim 1 wherein the reduced graphene oxide nanoplatforms comprise porosity, the porosity to receive an organic corrosion inhibitor.

5. The additive of claim 4 wherein the organic corrosion inhibitor is sodium lignosulfonate.

6. A hydrothermal method for manufacturing an additive for use with an anti-corrosion coating, the method comprising the steps of:
a. forming graphene oxide (GO) nanoplatforms and dispersing in distilled water to form a generally uniform suspension;
b. dissolving Zn(NO₃)₂ and Ce(NO₃)₂ in water to form a solution;
c. adding the solution to the suspension to form a Ce—Zn doped GO suspension;
d. dissolving Nas(PO₄) in water to form a P solution;
e. adding the P solution to the Ce—Zn doped GO suspension to form a Ce—Zn—P doped GO suspension; and
f. heating and washing the Ce—Zn—P doped GO suspension to reduce the GO forming reduced GO nanoplatforms and form decorated Ce—Zn—P nanoparticles on the surface of the reduced GO nanoplatforms to form the additive.

7. The hydrothermal method of claim 6 further comprising the steps after step e. of:
dissolving sodium lignosulfonate in water to form a mixture; and
adding the mixture to the Ce—Zn—P doped GO suspension to load the sodium lignosulfonate on GO-Ce—Zn—P in the Ce—Zn—P doped GO suspension.

8. The hydrothermal method of claim 7 wherein the step of adding the mixture to the Ce—Zn—P doped GO suspension is conducted under a vacuum to remove air trapped between layers in the GO-Ce—Zn—P to allow access by the mixture.

9. A nanocarrier for anti-corrosion inhibitors, comprising:
a graphene oxide nanoplatform decorated with cerium-modified zinc phosphate nanopigments to form a CeZnP nanostructure, and
an organic corrosion inhibitor,
wherein the organic corrosion inhibitor is encapsulated within the CeZnP nanostructure.

10. The nanocarrier of claim 9, wherein the cerium-modified zinc phosphate nanopigments comprise Ce³⁺, Zn²⁺ and PO₄³⁻ inhibitive components.

11. The nanocarrier of claim 10, wherein the Ce³⁺, Zn²⁺ and PO₄³⁻ inhibitive components are released from the CeZnP nanostructure when dispersed in a coating.

12. The nanocarrier of claim 9, wherein the CeZnP nanostructure is a porous media and the organic corrosion inhibitor releasably interacts with the porous media.

13. The nanocarrier of claim 9 wherein the organic corrosion inhibitor is sodium lignosulfonate.
